(19) United States
(12) Patent Application Publication
(10) Pub. No.: US 2019/0165590 A1
(43) Pub. Date: May 30, 2019

(54) METHOD FOR INDICATING CHARGING STATUS, SYSTEM FOR INDICATING CHARGING STATUS, AND TERMINAL DEVICE

(71) Applicant: SHENZHEN ROYOLE TECHNOLOGIES CO. LTD., Shenzhen, Guangdong (CN)

(72) Inventor: Zegang YE, Shenzhen, Guangdong (CN)

(21) Appl. No.: 16/300,432

(22) PCT Filed: Nov. 8, 2016
(86) PCT No.: PCT/CN2016/105087

§ 371 Date: Nov. 9, 2018

(51) Int. Cl. H02J 7/00; G06F 1/3212; H01M 10/48

(52) U.S. Cl. CPC H02J 7/0047; H02J 2007/0049; H01M 10/48; G06F 1/3212

(57) ABSTRACT

Disclosed are a method for indicating charging status, a system for indicating charging status, and a terminal device. The method includes the following. When the terminal device is in a charging status, a current status of a rechargeable battery of the terminal device is determined, a display mode of a charging status indicator is determined according to the current status of the rechargeable battery, and the charging status indicator is displayed in the display mode. In the embodiment, the current status of the rechargeable battery can be determined by a user according to the displayed charging status indicator.

### TECHNICAL FIELD

The present disclosure relates to the technical field of charging, and particularly to a method for indicating charging status, a system for indicating charging status, and a terminal device.

### BACKGROUND

When a terminal device such as a mobile phone, a tablet computer, a handheld computer or the like is charged, the remaining battery capacity and a charging status indicator (such as a lightening-shaped indicator) can be generally displayed through a battery icon. The charging status indicator is used to indicate that the terminal device is currently in a charging status. In the whole charging process, the charging status indicator is displayed in a fixed display mode. Therefore, the current status of the rechargeable battery cannot be determined by a user according to the charging status indicator.

### SUMMARY

In view of the above, embodiments of the present disclosure provide a method for indicating charging status, a system for indicating charging status, and a terminal device, such that the current status of a rechargeable battery can be determined by a user according to a displayed charging status indicator.

A method for indicating charging status provided by the embodiments of the present disclosure is applied to a terminal device. The method includes the following. When the terminal device is in a charging status, a current status of a rechargeable battery of the terminal device is determined, a display mode of a charging status indicator is determined according to the current status of the rechargeable battery, and the charging status indicator is displayed in the display mode.

A system for indicating charging status provided by the embodiments of the present disclosure includes a status determining module configured to determine a current status of a rechargeable battery of the terminal device when the terminal device is in a charging status, a display mode determining module configured to determine a display mode of a charging status indicator according to the current status of the rechargeable battery, and a display controlling module configured to display the charging status indicator in the display mode.

A terminal device provided by the embodiments of the present disclosure includes a memory storing a set of program codes, and a processor configured to invoke the set of program codes to perform following acts. When the terminal device is in a charging status, a current status of a rechargeable battery of the terminal device is determined, a display mode of a charging status indicator is determined according to the current status of the rechargeable battery, and the charging status indicator is displayed in the display mode.

In the embodiments of the present disclosure, the display mode of the charging status indicator is determined according to the current status of the rechargeable battery, and the charging status indicator is displayed in the display mode, i.e., the display mode of the charging status indicator is related to the current status of the rechargeable battery. Therefore, the current status of the rechargeable battery can be determined by the user according to the displayed charging status indicator.

### BRIEF DESCRIPTION OF THE DRAWINGS

In order to illustrate technical solutions in embodiments of the present disclosure more clearly, the following briefly introduces the accompanying drawings required for describing the embodiments. Apparently, the accompanying drawings in the following description illustrate some but not exhaustive embodiments of the present disclosure. Those of ordinary skill in the art may also obtain other drawings based on these accompanying drawings without creative work.

FIG. 1 is a flow chart illustrating a method for indicating charging status according to an embodiment of the present disclosure.

FIG. 2 is a schematic diagram illustrating a battery icon displayed on a terminal device according to an embodiment of the present disclosure.

FIG. 3 is a schematic structural diagram illustrating a system for indicating charging status according to an embodiment of the present disclosure.

FIG. 4 is a schematic structural diagram illustrating a terminal device according to an embodiment of the present disclosure.

### DETAILED DESCRIPTION

Technical solutions of embodiments of the present disclosure will be described below clearly and completely in conjunction with the accompanying drawings of the embodiments of the present disclosure. Apparently, merely some but not all embodiments of the present disclosure are described. Based on the embodiments of the present disclosure, all the other embodiments, which a person ordinarily skilled in the art may obtain without paying creative work fall within the scope of protection of the present disclosure.

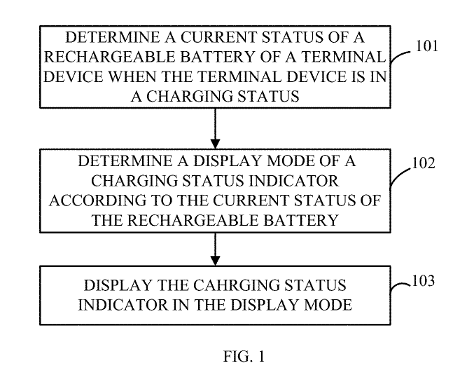

FIG. 1 is a schematic flow chart illustrating a method for indicating charging status according to an embodiment of the present disclosure. The method for indicating charging status is applied to a terminal device. The terminal device may have an image and text display function, for example, the terminal device may be a mobile phone, a tablet computer, a handheld computer, or the like. The method for indicating charging status includes the following.

Step 101, when the terminal device is in a charging status, a current status of a rechargeable battery of the terminal device is determined.

Step 102, a display mode of a charging status indicator is determined according to the current status of the rechargeable battery. The charging status indicator may be a pattern (or patterns), a character (or characters), a combination of a pattern (or patterns) and a character (or characters), or the like.

Step 103, the charging status indicator is displayed in the display mode.

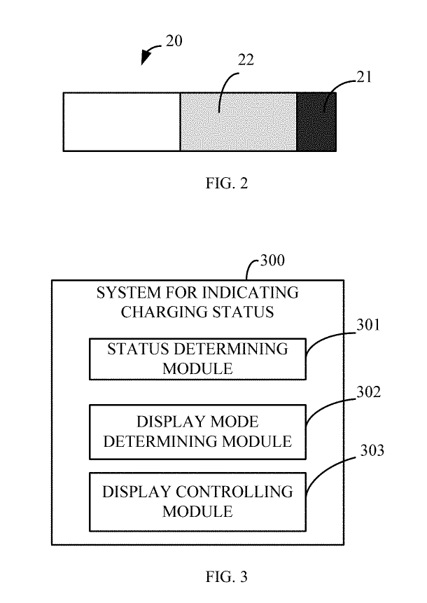

In a first implementation, displaying the charging status indicator in the display mode may include displaying the charging status indicator within a status bar in the display mode, where the status bar is displayed on the terminal device. The status bar may be displayed on a top edge, a bottom edge, or other position of the terminal device. The current time, a battery icon and so on may be displayed within the status bar. In an embodiment, the charging status indicator is displayed via the battery icon, for example, as illustrated in FIG. 2, the charging status indicator 22 is displayed via the battery icon 20, i.e., a remaining battery capacity indicator 21 and the charging status indicator 22 are both displayed via the battery icon 20.

In a second implementation, displaying the charging status indicator in the display mode may include displaying the charging status indicator in the display mode on an external electronic device in communication with the terminal device. For example, it is assumed that the terminal device is a tablet computer, and the external electronic device is a smart phone, in the process of charging the tablet computer, the tablet computer is in communication with the smart phone. The tablet computer controls the smart phone so as to display the charging status indicator in the display mode on the smart phone, for example, display the charging status indicator within the status bar displayed on the smart phone, by which in the process of charging the tablet computer, without viewing the tablet computer, the current status of the rechargeable battery of the tablet computer can be known in real time by the user when using the smart phone.

In the implementation, the display mode of the charging status indicator is determined according to the current status of the rechargeable battery, and the charging status indicator is displayed in the display mode, i.e., the display mode of the charging status indicator is related to the current status of the rechargeable battery, thus the current status of the rechargeable battery can be determined by the user according to the displayed charging status indicator.

In a first implementation, determining the current status of the rechargeable battery may include determining a charging phase that the rechargeable battery is currently in. Generally, the charging phase may include a trickle charging phase, a constant current charging phase, and a constant voltage charging phase. When the voltage of the rechargeable battery is quite low at the beginning of charging, a small current is needed to charge the rechargeable battery, i.e., the trickle charging is needed. When the voltage of the rechargeable battery is not low (e.g., higher than 2.9V) at the beginning of charging, the rechargeable battery does not need to be subjected to the trickle charging. When the voltage of the rechargeable battery is not low, a large current can be adopted to charge the rechargeable battery, i.e., the constant current charging can be adopted to charge the rechargeable battery. When the voltage of the rechargeable battery reaches or approaches the voltage of a full charging (for example, 4.2V or 4.3V, for different rechargeable batteries, voltages of a full charging are different), the constant voltage charging is adopted, the charging voltage is kept unchanged, and the charging current is gradually reduced. The charging phase that the rechargeable battery is currently in can be determined according to at least one of the charging current currently adopted and the remaining battery capacity. For example, when the charging current is lower than 100 mA and the remaining battery capacity is lower than 5%, it is determined that the rechargeable battery is currently in the trickle charging phase. When the charging current is higher than 100 mA and the remaining battery capacity falls within a range from 6% to 90%, it is determined that the rechargeable battery is currently in the constant current charging phase. When the remaining battery capacity is higher than 90%, it is determined that the rechargeable battery is currently in the constant voltage charging phase.

In the first implementation, determining the display mode of the charging status indicator according to the current status of the rechargeable battery may include determining a frame rate of the charging status indicator according to the charging phase that the rechargeable battery is currently in. Displaying the charging status indicator in the display mode may include refreshing the charging status indicator according to the frame rate. When the rechargeable battery is in the trickle charging phase, the frame rate of the charging status indicator is lower than that when the rechargeable battery is in the constant current charging phase, and is higher than that when the rechargeable battery is in the constant voltage charging phase. Different frame rates are set for different charging phases, thus the charging status indicator can be displayed in a slow motion mode or a fast motion mode. For example, when the charging status indicator is a pattern, the pattern can be displayed in the slow motion mode or the fast motion mode. Similarly, when the charging status indicator is a character or a combination of a pattern and a character, the character or the combination of the pattern and the character can also be displayed in the slow motion mode or the fast motion mode. Therefore, the charging phase that the rechargeable battery is currently in can be determined by the user according to the dynamic display of the charging status indicator.

Alternatively, frame rates of the charging status indicator corresponding to different charging phases can be set in advance. For example, the frame rate of the charging status indicator corresponding to the trickle charging phase is set to be 10 fps in advance, the frame rate of the charging status indicator corresponding to the constant current charging phase is set to be 30 fps in advance, and the frame rate of the charging status indicator corresponding to the constant voltage charging phase is set to be 5 fps in advance.

Alternatively, in the charging process, the frame rate of the charging status indicator can also be calculated according to the remaining battery capacity of the rechargeable battery and the charging current. For example, it is assumed that at the time point T1 of entering a certain charging phase (for example, the trickle charging phase), the remaining battery capacity of the rechargeable battery is Q1, the charging current is C1, and after entering the charging phase, at the time point T2, the remaining battery capacity of the rechargeable battery is changed to Q2, the charging current is changed to C2, thus an average charging current C-avg within the time interval from T1 to T2 is (C2−C1)/2, an average charging time T-avg is (Q2−Q1)/C-avg, an actual charging time T-actual within the time interval from T1 to T2 is T2−T1, thus the frame rate F of the charging status indicator is (T-avg/T-actual)*F0, where F0 is a fixed value set in advance, and F0 is generally the frame rate of the charging status indicator corresponding to the constant current charging phase, which frame rate may be 30 fps. When the trickle charging is adopted, the charging current is gradually increased, the actual charging time is longer than the average charging time, T-avg/T-actual is smaller than one, thus F is smaller than F0. The constant current charging refers to fast charging, T-avg can be deemed to be equal to T-actual, thus F can be deemed to be equal to F0. When the constant voltage charging is adopted, the charging current is gradually decreased, the actual charging time is longer than the average charging time, T-avg/T-actual is smaller than one, thus F is smaller than F0. Generally speaking, a ratio of T-avg to T-actual calculated when the trickle charging is adopted is higher than that calculated when the constant voltage charging is adopted, thus the frame rate calculated when the trickle charging is adopted is higher than that calculated when the constant voltage charging is adopted.

In the first implementation, the frame rate of the charging status indicator is related to the charging phase that the rechargeable battery is currently in, thus the charging phase that the rechargeable battery is currently in can be determined by the user according to the displayed charging status indicator.

In a second implementation, determining the current status of the rechargeable battery may include determining the charging phase that the rechargeable battery is currently in and determining current temperature of the rechargeable battery. The manner in which the charging phase that the rechargeable battery is currently in is determined is substantially the same as the above described manner, and will not be repeated herein. The current temperature of the rechargeable battery can be determined by arranging a temperature sensor adjacent to the rechargeable battery. Determining the display mode of the charging status indicator according to the current status of the rechargeable battery may include determining the frame rate of the charging status indictor according to the charging phase that the rechargeable battery is currently in, and determining the display color of the charging status indicator according to the current temperature of the rechargeable battery. The manner in which the frame rate of the charging status indicator is determined is substantially the same as the above described manner, and will not be repeated herein. The display color of the charging status indicator can be set to be gradually darker when the temperature of the rechargeable battery gradually increases. For example, the display color of the charging status indicator can be set to be light grey when the current temperature of the rechargeable battery falls within a range from 30 degrees centigrade to 40 degrees centigrade, the display color of the charging status indicator can be set to be dark grey when the current temperature of the rechargeable battery falls within a range from 41 degrees centigrade to 50 degrees centigrade, and the display color of the charging status indicator can be set to be black when the current temperature of the rechargeable battery falls within a range from 51 degrees centigrade to 65 degrees centigrade. Displaying the charging status indicator in the display mode may include displaying the charging status indicator according to the display color, and refreshing the charging status indicator according to the frame rate. For example, when the charging status indicator is a pattern, the pattern can be displayed in the slow motion mode or the fast motion mode, and the color of the pattern can be set according to the current temperature of the rechargeable battery. Similarly, when the charging status indicator is a character or a combination of a pattern and a character, the character or the combination of the pattern and the character can be displayed in the slow motion mode or the fast motion mode, and the color of the character or the color of the combination of the pattern and the character can be set according to the current temperature of the rechargeable battery.

In the second implementation, the frame rate of the charging status indicator is related to the charging phase that the rechargeable battery is currently in, and the display color of the charging status indicator is related to the current temperature of the rechargeable battery, thus according to the displayed charging status indicator, the charging phase that the rechargeable battery is currently in and whether the current temperature of the rechargeable battery is high can be both determined by the user.

In a third implementation, determining the current status of the rechargeable battery may include determining the current temperature of the rechargeable battery. The manner in which the current temperature of the rechargeable battery is determined is substantially the same as the above described manner, and will not be repeated herein. Determining the display mode of the charging status indicator according to the current status of the rechargeable battery may include determining the display color of the charging status indicator according to the current temperature of the rechargeable battery. The manner in which the display color of the charging status indicator is determined is the same as the above described manner, and will not be repeated herein. Displaying the charging status indicator in the display mode may include displaying the charging status indicator according to the display color. For example, when the charging status indicator is a pattern, the color of the pattern can be set according to the current temperature of the rechargeable battery. Similarly, when the charging status indicator is a character or a combination of a pattern and a character, the color of the pattern or the color of the combination of the pattern and the character can be set according to the current temperature of the rechargeable battery.

In the third implementation, the display color of the charging status indicator is related to the current temperature of the rechargeable battery, thus whether the current temperature of the rechargeable battery is high can be determined by the user according to the display color of the charging status indicator.

As illustrated in FIG. 3, a schematic structural diagram illustrating a system for indicating charging status according to an embodiment of the present disclosure is provided. A system 300 for indicating charging status is applied to a terminal device. The terminal device may have an image and text display function, and may be a smart phone, a tablet computer, a handheld computer, or the like. The system 300 for indicating charging status may include a status determining module 301, a display mode determining module 302, and a display controlling module 303.

The status determining module 301 is configured to determine a current status of a rechargeable battery of the terminal device when the terminal device is in a charging status.

The display mode determining module 302 is configured to determine a display mode of a charging status indicator according to the current status of the rechargeable battery.

The display controlling module 303 is configured to display the charging status indicator in the display mode. The charging status indicator may be a pattern (or patterns), a character (or characters), a combination of a pattern (or patterns) and a character (or characters), or the like.

In a first implementation, the display controlling module 303 displaying the charging status indicator in the display mode may include that the display controlling module 303 displays the charging status indicator within a status bar in the display mode, where the status bar is displayed on the terminal device. The status bar may be displayed on a top edge, a bottom edge, or other position of the terminal device. The current time, a battery icon and so on may be displayed within the status bar. In an embodiment, the charging status indicator is displayed via the battery icon, for example, as illustrated in FIG. 2, the charging status indicator 22 is displayed via the battery icon 20, i.e., a remaining battery capacity indicator 21 and the charging status indicator 22 are both displayed via the battery icon 20.

In a second implementation, the display controlling module 303 displaying the charging status indicator in the display mode may include that the display controlling module 303 displays the charging status indicator in the display mode on an external electronic device in communication with the terminal device. For example, it is assumed that the terminal device is a tablet computer, and the external electronic device is a smart phone, in the process of charging the tablet computer, the tablet computer is in communication with the smart phone. The tablet computer controls the smart phone so as to display the charging status indicator in the display mode on the smart phone, for example, display the charging status indicator within the status bar displayed on the smart phone, by which in the process of charging the tablet computer, without viewing the tablet computer, the current status of the rechargeable battery of the tablet computer can be known in real time by the user when using the smart phone.

In the implementation, the display mode of the charging status indicator is determined according to the current status of the rechargeable battery, and the charging status indicator is displayed in the display mode, i.e., the display mode of the charging status indicator is displayed is related to the current status of the rechargeable battery, thus the current status of the rechargeable battery can be determined by the user according to the displayed charging status indicator.

In a first implementation, the status determining module 301 determining the current status of the rechargeable battery may include that the status determining module 301 determines a charging phase that the rechargeable battery is currently in. Generally, the charging phase may include a trickle charging phase, a constant current charging phase, and a constant voltage charging phase. When the voltage of the rechargeable battery is quite low at the beginning of charging, a small current is needed to charge the rechargeable battery, i.e., the trickle charging is needed. When the voltage of the rechargeable battery is not low (e.g., higher than 2.9V) at the beginning of charging, the rechargeable battery does not need to be subjected to the trickle charging. When the voltage of the rechargeable battery is not low, a large current can be adopted to charge the rechargeable battery, i.e., the constant current charging can be adopted to charge the rechargeable battery. When the voltage of the rechargeable battery reaches or approaches the voltage of a full charging (for example, 4.2V or 4.3V, for different rechargeable batteries, voltages of a full charging are different), the constant voltage charging is adopted, the charging voltage is kept unchanged, and the charging current is gradually reduced. The charging phase that the rechargeable battery is currently in can be determined according to at least one of the charging current currently adopted and the remaining battery capacity. For example, when the charging current is lower than 100 mA and the remaining battery capacity is lower than 5%, it is determined that the rechargeable battery is currently in the trickle charging phase. When the charging current is higher than 100 mA and the remaining battery capacity falls within a range from 6% to 90%, it is determined that the rechargeable battery is currently in the constant current charging phase. When the remaining battery capacity is higher than 90%, it is determined that the rechargeable battery is currently in the constant voltage charging phase.

In the first implementation, the display mode determining module 302 determining the display mode of the charging status indicator according to the current status of the rechargeable battery may include that the display mode determining module 302 determines a frame rate of the charging status indicator according to the charging phase that the rechargeable battery is currently in. The display controlling module 303 displaying the charging status indicator in the display mode may include that the display controlling module 303 refreshes the charging status indicator according to the frame rate. When the rechargeable battery is in the trickle charging phase, the frame rate of the charging status indicator is lower than that when the rechargeable battery is in the constant current charging phase, and is higher than that when the rechargeable battery is in the constant voltage charging phase. Different frame rates are set for different charging phases, thus the charging status indicator can be displayed in a slow motion mode or a fast motion mode. For example, when the charging status indicator is a pattern, the pattern can be displayed in the slow motion mode or the fast motion mode. Similarly, when the charging status indicator is a character or a combination of a pattern and a character, the character or the combination of the pattern and the character can also be displayed in the slow motion mode or the fast motion mode. Therefore, the charging phase that the rechargeable battery is currently in can be determined by the user according to the dynamic display of the charging status indicator.

Alternatively, frame rates of the charging status indicator corresponding to different charging phases can be set in advance. For example, the frame rate of the charging status indicator corresponding to the trickle charging phase is set to be 10 fps in advance, the frame rate of the charging status indicator corresponding to the constant current charging phase is set to be 30 fps in advance, and the frame rate of the charging status indicator corresponding to the constant voltage charging phase is set to be 5 fps in advance.

Alternatively, in the charging process, the frame rate of the charging status indicator can also be calculated according to the remaining battery capacity of the rechargeable battery and the charging current. For example, it is assumed that at the time point T1 of entering a certain charging phase (for example, the trickle charging phase), the remaining battery capacity of the rechargeable battery is Q1, the charging current is C1, and after entering the charging phase, at the time point T2, the remaining battery capacity of the rechargeable battery is changed to Q2, the charging current is changed to C2, thus an average charging current C-avg within the time interval from T1 to T2 is (C2−C1)/2, an average charging time T-avg is (Q2−Q1)/C-avg, an actual charging time T-actual within the time interval from T1 to T2 is T2-T1, thus the frame rate F of the charging status indicator is (T-avg/T-actual)*F0, where F0 is a fixed value set in advance, and F0 is generally the frame rate of the charging status indicator corresponding to the constant current charging phase, which frame rate may be 30 fps. When the trickle charging is adopted, the charging current is gradually increased, the actual charging time is longer than the average charging time, T-avg/T-actual is smaller than one, thus F is smaller than F0. The constant current charging refers to fast charging, T-avg can be deemed to be equal to T-actual, thus F can be deemed to be equal to F0. When the constant voltage charging is adopted, the charging current is gradually decreased, the actual charging time is longer than the average charging time, T-avg/T-actual is smaller than one, thus F is smaller than F0. Generally speaking, a ratio of T-avg to T-actual calculated when the trickle charging is adopted is higher than that calculated when the constant voltage charging is adopted, thus the frame rate calculated when the trickle charging is adopted is higher than that calculated when the constant voltage charging is adopted.

In the first implementation, the frame rate of the charging status indicator is related to the charging phase that the rechargeable battery is currently in, thus the charging phase that the rechargeable battery is currently in can be determined by the user according to the charging status indicator.

In a second implementation, the status determining module 301 determining the current status of the rechargeable battery may include that the status determining module 301 determines the charging phase that the rechargeable battery is currently in and determines current temperature of the rechargeable battery. The manner in which the charging phase that the rechargeable battery is currently in is determined is substantially the same as the above described manner, and will not be repeated herein. The current temperature of the rechargeable battery can be determined by arranging a temperature sensor adjacent to the rechargeable battery. The display mode determining module 302 determining the display mode of the charging status indicator according to the current status of the rechargeable battery may include that the display mode determining module 302 determines the frame rate of the charging status indictor according to the charging phase that the rechargeable battery is currently in, and determines the display color of the charging status indicator according to the current temperature of the rechargeable battery. The manner in which the frame rate of the charging status indicator is determined is substantially the same as the above described manner, and will not be repeated herein. The display color of the charging status indicator can be set to be gradually darker when the temperature of the rechargeable battery gradually increases. For example, the display color of the charging status indicator can be set to be light grey when the current temperature of the rechargeable battery falls within a range from 30 degrees centigrade to 40 degrees centigrade, the display color of the charging status indicator can be set to be dark grey when the current temperature of the rechargeable battery falls within a range from 41 degrees centigrade to 50 degrees centigrade, and the display color of the charging status indicator can be set to be black when the current temperature of the rechargeable battery falls within a range from 51 degrees centigrade to 65 degrees centigrade. The display controlling module 303 displaying the charging status indicator in the display mode may include that the display controlling module 303 displays the charging status indicator according to the display color, and refreshes the charging status indicator according to the frame rate. For example, when the charging status indicator is a pattern, the pattern can be displayed in the slow motion mode or the fast motion mode, and the color of the pattern can be set according to the current temperature of the rechargeable battery. Similarly, when the charging status indicator is a character or a combination of a pattern and a character, the character or the combination of the pattern and the character can be displayed in the slow motion mode or the fast motion mode, and the color of the character or the color of the combination of the pattern and the character can be set according to the current temperature of the rechargeable battery.

In the second implementation, the frame rate of the charging status indicator is related to the charging phase that the rechargeable battery is currently in, and the display color of the charging status indicator is related to the current temperature of the rechargeable battery, thus according to the displayed charging status indicator, the charging phase that the rechargeable battery is currently in and whether the current temperature of the rechargeable battery is high can be both determined by the user.

In a third implementation, the status determining module 301 determining the current status of the rechargeable battery may include that the status determining module 301 determines the current temperature of the rechargeable battery. The manner in which the current temperature of the rechargeable battery is determined is substantially the same as the above described manner, and will not be repeated herein. The display mode determining module 302 determining the display mode of the charging status indicator according to the current status of the rechargeable battery may include that the display mode determining module 302 determines the display color of the charging status indicator according to the current temperature of the rechargeable battery. The manner in which the display color of the charging status indicator is determined is the same as the above described manner, and will not be repeated herein. The display controlling module 303 displaying the charging status indicator in the display mode may include that the display controlling module 303 displays the charging status indicator according to the display color. For example, when the charging status indicator is a pattern, the color of the pattern can be set according to the current temperature of the rechargeable battery. Similarly, when the charging status indicator is a character or a combination of a pattern and a character, the color of the character or the color of the combination of the pattern and the character can be set according to the current temperature of the rechargeable battery.

In the third implementation, the display color of the charging status indicator is related to the current temperature of the rechargeable battery, thus whether the current temperature of the rechargeable battery is high can be determined by the user according to the display color of the charging status indicator.

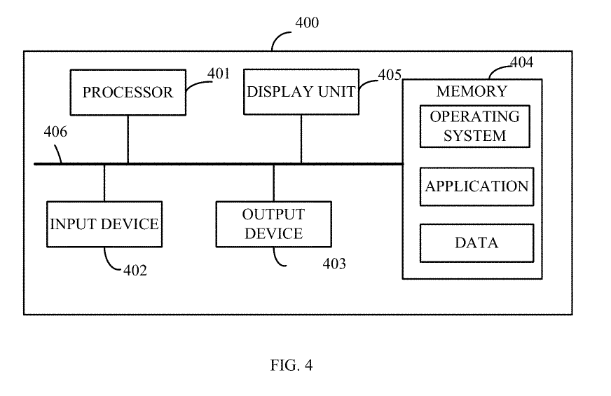

As illustrated in FIG. 4, in an implementation of the present disclosure, a terminal device 400 can be used to execute the method for indicating charging status provided in the embodiments of the present disclosure. The terminal device 400 may include at least one processor 401, at least one input device 402, at least one output device 403, a memory 404, a display unit 405, and so on. These components communicate with each other via one or more buses 406. A person of ordinary skill in the art can understand that the structure of the terminal device 400 illustrated in FIG. 4 does not limit the present disclosure. The terminal device may be a bus structure or a star structure. The terminal device may include more or fewer components than illustrated, or may combine certain components, or may include different components.

In the embodiment of the present disclosure, the processor 401 is the control center of the terminal device 400, it connects various parts of the whole terminal device 400 through various interfaces and lines, runs or executes software programs and/or units stored in the memory 404 and invokes data stored in the memory 404 to perform various functions of the terminal device 400 and process data. The processor 401 may be formed by one or more integrated circuits (ICs). For example, the processor 401 may be formed by a single encapsulated IC, and also may be formed by connecting multiple encapsulated ICs having the same function or different functions. For example, the processor 401 may just include a central processing unit (CPU), and also may be a combination of the CPU, a digital signal processor (DSP), a graphic processing unit (GPU), and various control chips. In the embodiment of the present disclosure, the CPU may include a signal core, or multiple cores.

In the embodiment of the present disclosure, the input device 402 may include a standard touch screen, a keyboard, and so on, and also may include a wired interface, a wireless interface, and so on, to realize interaction between a user and the terminal device 400.

In the embodiment of the present disclosure, the output device 403 may be a display screen, a loudspeaker, and may include a wired interface, a wireless interface, and so on.

In the embodiment of the present disclosure, the memory 404 may include at least one of the follows: a random access memory, a nonvolatile memory, and an external memory. The memory 404 may store program codes. The processor 401 performs the above method for indicating charging status by invoking the program codes stored in the memory 404. The memory 404 mainly includes a program storage area and a data storage area. The program storage area may store an operating system, applications for at least one function, and so on. The data storage area may store data created according to usage of the display apparatus and so on. In the embodiment of the present disclosure, the operating system may be the Android system, the iOS system, the Windows operating system, or other.

In the embodiment of the present disclosure, the display unit 405 is operable to display information such as images, text and so on, and may be a light-emitting diode display unit, a liquid crystal display unit, and the like.

The above disclosures illustrate preferable embodiments of the present disclosure. It should be pointed out that a person of ordinary skill in the art can make several changes and polish without departing from the principle of the present disclosure, and these changes and polish shall be deemed as the scope of protection of the present disclosure.

1. A method for indicating charging status, the method being applied to a terminal device, and comprising:
determining a current status of a rechargeable battery of the terminal device when the terminal device is in a charging status;
determining a display mode of a charging status indicator according to the current status of the rechargeable battery; and
displaying the charging status indicator in the display mode.

2. The method for indicating charging status of claim 1, wherein
the determining a current status of a rechargeable battery comprises: determining a charging phase that the rechargeable battery is currently in;
the determining a display mode of a charging status indicator according to the current status of the rechargeable battery comprises: determining a frame rate of the charging status indicator according to the charging phase that the rechargeable battery is currently in;
the displaying the charging status indicator in the display mode comprises: refreshing the charging status indicator according to the frame rate.

3. The method for indicating charging status of claim 1, wherein
the determining a current status of a rechargeable battery comprises: determining a charging phase that the rechargeable battery is currently in, and determining current temperature of the rechargeable battery;
the determining a display mode of a charging status indicator according to the current status of the rechargeable battery comprises: determining a frame rate of the charging status indicator according to the charging phase that the rechargeable battery is currently in, and determining a display color of the charging status indicator according to the current temperature of the rechargeable battery;
the displaying the charging status indicator in the display mode comprises: displaying the charging status indicator according to the display color, and refreshing the charging status indicator according to the frame rate.

4. The method for indicating a charging status of claim 2, wherein the charging phase comprises a trickle charging phase, a constant current charging phase, and a constant voltage charging phase; when the rechargeable battery is in the trickle charging phase, a frame rate of the charging status indicator is lower than that when the rechargeable battery is in the constant current charging phase, and is higher than that when the rechargeable battery is in the constant voltage charging phase.

5. The method for indicating charging status of claim 1, wherein
the determining a current status of a rechargeable battery comprises: determining current temperature of the rechargeable battery;
the determining a display mode of a charging status indicator according to the current status of the rechargeable battery comprises: determining a display color of the charging status indicator according to the current temperature of the rechargeable battery;
the displaying the charging status indicator in the display mode comprises: displaying the charging status indicator according to the display color.

6-10. (canceled)

11. A terminal device, comprising:
at least one processor; and
a computer readable memory, coupled to the at least one processor and storing at least one computer executable instruction therein which, when executed by the at least processor, causes the at least one processor to:
determine a current status of a rechargeable battery of the terminal device when the terminal device is in a charging status;
determine a display mode of a charging status indicator according to the current status of the rechargeable battery; and
display the charging status indicator in the display mode.

12. The terminal device of claim 11, wherein
the at least one computer executable instruction causing the at least one processor to determine the current status of the rechargeable battery causes the at least one processor to determine a charging phase that the rechargeable battery is currently in;
the at least one computer executable instruction causing the at least one processor to determine the display mode of the charging status indicator according to the current status of the rechargeable battery causes the at least one processor to determine a frame rate of the charging status indicator according to the charging phase that the rechargeable battery is currently in;
the at least one computer executable instruction causing the at least one processor to display the charging status indicator in the display mode causes the at least one processor to refresh the charging status indicator according to the frame rate.

13. The terminal device of claim 11, wherein
the at least one computer executable instruction causing the at least one processor to determine the current status of the rechargeable battery causes the at least one processor to determine a charging phase that the rechargeable battery is currently in, and determine current temperature of the rechargeable battery;
the at least one computer executable instruction causing the at least one processor to determine the display mode of the charging status indicator according to the current status of the rechargeable battery causes the at least one processor to determine a frame rate of the charging status indicator according to the charging phase that the rechargeable battery is currently in, and determine a display color of the charging status indicator according to the current temperature of the rechargeable battery;
the at least one computer executable instruction causing the at least one processor to display the charging status indicator in the display mode causes the at least one processor to display the charging status indicator according to the display color, and refresh the charging status indicator according to the frame rate.

14. The terminal device of claim 12, wherein the charging phase comprises a trickle charging phase, a constant current charging phase, and a constant charging phase; when the rechargeable battery is in the trickle charging phase, a frame rate of the charging status indicator is lower than that when the rechargeable battery is in the constant current charging phase, and is higher than that when the rechargeable battery is in the constant voltage charging phase.

15. The terminal device of claim 11, wherein
the at least one computer executable instruction causing the at least one processor to determine a current status of a rechargeable battery causes the at least one processor to: determine current temperature of the rechargeable battery;
the at least one computer executable instruction causing the at least one processor to determine the display mode of the charging status indicator according to the current status of the rechargeable battery causes the at least one processor to determine a display color of the charging status indicator according to the current temperature of the rechargeable battery; and
the at least one computer executable instruction causing the at least one processor to display the charging status indicator in the display mode causes the at least one processor to display the charging status indicator according to the display color.

16. A non-transitory computer-readable storage medium storing at least one computer executable instruction which, when executed by a processor, causes the processor to carry out actions, comprising:
determining a current status of a rechargeable battery of the terminal device when the terminal device is in a charging status;
determining a display mode of a charging status indicator according to the current status of the rechargeable battery; and
displaying the charging status indicator in the display mode.

17. The non-transitory computer-readable storage medium of claim 16, wherein
the at least one computer executable instruction executed by the processor to carry out the action of determining a current status of a rechargeable battery is executed by the processor to carry out an action, comprising: determining a charging phase that the rechargeable battery is currently in;
the at least one computer executable instruction executed by the processor to carry out the action of determining a display mode of a charging status indicator according to the current status of the rechargeable battery is executed by the processor to carry out an action, comprising: determining a frame rate of the charging status indicator according to the charging phase that the rechargeable battery is currently in;
the at least one computer executable instruction executed by the processor to carry out the action of displaying the charging status indicator in the display mode is executed by the processor to carry out an action, comprising: refreshing the charging status indicator according to the frame rate.

18. The non-transitory computer-readable storage medium of claim 16, wherein
the at least one computer executable instruction executed by the processor to carry out the action of determining a current status of a rechargeable battery is executed by the processor to carry out an action, comprising: determining a charging phase that the rechargeable battery is currently in, and determining current temperature of the rechargeable battery;
the at least one computer executable instruction executed by the processor to carry out the action of determining a display mode of a charging status indicator according to the current status of the rechargeable battery is executed by the processor to carry out actions, comprising: determining a frame rate of the charging status indicator according to the charging phase that the rechargeable battery is currently in, and determining a display color of the charging status indicator according to the current temperature of the rechargeable battery;
the at least one computer executable instruction executed by the processor to carry out the action of displaying the charging status indicator in the display mode is executed by the processor to carry out actions, comprising: displaying the charging status indicator according to the display color, and refreshing the charging status indicator according to the frame rate.

19. The non-transitory computer-readable storage medium of claim 17, wherein the charging phase comprises a trickle charging phase, a constant current charging phase, and a constant charging phase; when the rechargeable battery is in the trickle charging phase, a frame rate of the charging status indicator is lower than that when the rechargeable battery is in the constant current charging phase, and is higher than that when the rechargeable battery is in the constant voltage charging phase.

20. The non-transitory computer-readable storage medium of claim 16, wherein
the at least one computer executable instruction executed by the processor to carry out the action of determining a current status of a rechargeable battery is executed by the processor to carry out an action, comprising: determining current temperature of the rechargeable battery;
the at least one computer executable instruction executed by the processor to carry out the action of determining a display mode of a charging status indicator according to the current status of the rechargeable battery is executed by the processor to carry out an action, comprising: determining a display color of the charging status indicator according to the current temperature of the rechargeable battery; and
the at least one computer executable instruction executed by the processor to carry out the action of displaying the charging status indicator in the display mode is executed by the processor to carry out an action, comprising: displaying the charging status indicator according to the display color.
